(19) United States
(12) Patent Application Publication
(10) Pub. No.: US 2026/0324666 A1
(43) Pub. Date: Oct. 22, 2026

(54) CREAM PUFF PASTRY OIL/FAT COMPOSITION

(71) Applicant: The Nisshin OilliO Group, Ltd., Tokyo (JP)

(72) Inventors: Yoshimune HASOME, Kanagawa (JP); Miho MORITA, Kanagawa (JP); Yuuma OGASA

(21) Appl. No.: 19/113,255

(22) PCT Filed: Sep. 11, 2023
(86) PCT No.: PCT/JP2023/033082

§ 371 Date: Mar. 19, 2025

(30) Foreign Application Priority Data
Sep. 27, 2022 (JP) 2022-154194

(51) Int. Cl. A23D 9/007; A21D 2/16; A21D 2/26; A21D 13/32; A21D 13/80; A23D 9/04

(52) U.S. Cl. CPC A23D 9/007; A21D 2/165; A21D 2/263; A21D 13/32; A21D 13/80; A23D 9/04

(57) ABSTRACT

An object of the present invention is to provide a fats and oils composition for a choux pastry having a high content of sodium caseinate and/or casein peptide. Another object of the present invention is to provide a suitable method for producing for a fats and oils composition for a choux pastry having a high content of sodium caseinate and/or casein peptide. The present invention is: a fats and oils composition for a choux pastry including 5 to 70 mass % of sodium caseinate and/or casein peptide and 25 to 90 mass % of fats and oils; the fats and oils composition for a choux pastry in which the fats and oils contain a fats and oils powder; and the fats and oils composition for a choux pastry which is substantially anhydrous.

### TECHNICAL FIELD

The present invention relates to a fats and oils composition for a choux pastry.

### BACKGROUND ART

In general, a method for producing a choux pastry starts with preparation of a choux pastry dough. The choux pastry dough is prepared, for example, by boiling water, adding fats and oils such as butter to the boiled water, further adding flour to the boiled water, stirring the mixture well, and finally adding chicken eggs. Then, the choux pastry dough thus obtained is piped out and baked in an oven or the like, so that a choux pastry with voids can be produced.

However, skill is needed to produce a choux pastry excellent in texture and taste as compared with bread and confectionery. Moreover, it has been extremely difficult to stably produce such a choux pastry. Therefore, various efforts have been made to stably produce a choux pastry having good texture and quality. For example, Patent Literature 1 discloses a technique in which anyone can stably and easily produce a choux pastry by using an oil-in-water emulsion composition containing 5 to 70% of fats and oils and 1.5 to 5% of sodium caseinate. Patent Literature 2 proposes a production method in which an emulsified fats and oils composition to be used in the method for producing a choux pastry contains 0.07 to 0.14 wt % of enzyme-treated egg yolk oil and 3 to 6 wt % of sodium caseinate without containing phosphate in the aqueous phase part, thereby improving the solubility of sodium caseinate.

### CITATION LIST

### Patent Literature

Patent Literature 1: JP-A-9-266750
Patent Literature 2: JP-A-2015-112063

### SUMMARY OF INVENTION

### Problems to be Solved by Invention

However, these compositions for a choux pastry are not easy to produce because it is necessary to dissolve sodium caseinate in the aqueous phase. Further, the amount of sodium caseinate that can be blended in the composition was small. Therefore, there has been a demand for a composition for a choux pastry that is easy to produce even when the content of sodium caseinate or the like is high.

An object of the present invention is to provide a fats and oils composition for a choux pastry having a high content of sodium caseinate and/or casein peptide. Another object of the present invention is to provide a suitable method for producing for a fats and oils composition for a choux pastry having a high content of sodium caseinate and/or casein peptide.

### Solution to Problems

The present inventors have found that the above problems can be solved by preparing a fats and oils composition in which a specific amount of casein and/or casein peptide is dispersed in a specific amount of fats and oils. Thus, the present invention has been completed. That is, the present invention may be the following aspects.
[1] A fats and oils composition for a choux pastry, including 5 to 70 mass % of sodium caseinate and/or casein peptide and 25 to 90 mass % of fats and oils.
[2] The fats and oils composition for a choux pastry according to [1], in which the fats and oils contain a fats and oils powder.
[3] The fats and oils composition for a choux pastry according to [1], which is substantially anhydrous
[4] A choux pastry dough including 0.8 to 16 mass % of the fats and oils composition for a choux pastry according to any one of [1] to [3].
[5] A choux pastry in a state in which the choux pastry dough of [4] is baked.
[6] A method of producing the fats and oils composition for a choux pastry according to any one of [1] to [3], including
dispersing powdery sodium caseinate and/or casein peptide in at least fats and oils in a flowing state.

### Effects of Invention

According to the present invention, a fats and oils composition for a choux pastry having a high content of sodium caseinate and/or casein peptide can be provided. Further, according to the present invention, a method of easily producing a fats and oils composition for a choux pastry having a high content of sodium caseinate and/or casein peptide can be provided.

### DESCRIPTION OF EMBODIMENTS

Hereinafter, the fats and oils composition for a choux pastry of the present invention will be described in order.

The fats and oils composition for a choux pastry of the present invention includes 5 to 70 mass % of sodium caseinate and/or casein peptide. Casein is a protein derived from milk. Examples of the protein derived from milk include whey protein in addition to casein. Sodium caseinate is obtained, for example, as a neutralized product of casein curds, which are acid precipitates of skimmed milk. An example of the casein peptide include a peptide obtained by hydrolyzing casein (for example, sodium caseinate) with an enzyme such as protease. The amount of sodium caseinate and/or casein peptide contained in the fats and oils composition for a choux pastry is preferably 10 to 60 mass % and more preferably 15 to 50 mass %. When sodium caseinate and casein peptide are used in combination, the ratio of casein peptide to the total amount of sodium caseinate and casein peptide is preferably 50 mass % or more, more preferably 70 mass % or more, and still more preferably 80 mass % or more.

According to an embodiment of the present invention, sodium caseinate and/or casein peptide contained in the fats and oils composition for a choux pastry may be in the form of a powder when mixed with fats and oils. Since powdery sodium caseinate and/or casein peptide can be directly used in the fats and oils composition of the present invention, there is no time and effort to dissolve sodium caseinate and/or casein peptide in water, and the fats and oils composition is easy to produce as compared with the case where sodium caseinate and/or casein peptide are used in the form of an aqueous solution. In addition, the fats and oils composition of the present invention is easy to handle, is substantially anhydrous, and thus is also excellent in hygiene. The term “substantially anhydrous” means that the moisture contained in the fats and oils composition is 7 mass % or less, preferably 5 mass % or less, and more preferably 3 mass % or less. The moisture contained in the fats and oils composition can be measured by a conventionally known method such as a normal pressure heat drying method.

The fats and oils composition for a choux pastry of the present invention includes 25 to 90 mass % of fats and oils.

The “fats and oils” used in the present invention are not particularly limited as long as they are fats and oils (edible fats and oils) suitable for food. Examples of the edible fats and oils include soybean oil, rapeseed oil, corn oil, sunflower oil, safflower oil, sesame oil, cottonseed oil, rice oil, olive oil, peanut oil, linseed oil, palm oil, palm kernel oil, coconut oil, cacao butter, and milk fat, as well as mixed oils of these fats and oils, and processed fats and oils (interesterified oil, fractionated oil, hydrogenated oil, and the like) of these fats and oils or mixed oils. One or two or more of the edible fats and oils may be appropriately selected and used. The amount of the fats and oils contained in the fats and oils composition for a choux pastry is preferably 35 to 85 mass % and more preferably 45 to 80 mass %.

According to an embodiment of the present invention, the fats and oils contained in the fats and oils composition for choux preferably have an SFC (solid fat content) of 5 to 60% at 10 °C and 1 to 35% at 25 °C. The SFC of the fats and oils contained in the fats and oils composition is more preferably 7 to 55% at 10 °C and 2 to 32% at 25 °C, and still more preferably 8 to 50% at 10 °C and 3 to 30% at 25 °C. When the SFC of the fats and oils contained in the fats and oils composition is in the above range, the fats and oils composition tends to have plasticity at the use temperature, and thus achieve good workability. The SFC of fats and oils can be measured in accordance with 2.2.9-2003 Solid fat content (NMR method) of “Standard methods for the analysis of fats, oils and related materials (edited by Japan Oil Chemists' Society)”.

According to an embodiment of the present invention, a part of the fats and oils contained in the fats and oils composition for a choux pastry may be a fats and oils powder having a melting point of 50 °C or higher as described later. According to another embodiment of the present invention, the fats and oils contained in the fats and oils composition for a choux pastry may contain liquid oil in an amount of preferably 50 mass % or more, more preferably 70 mass % or more, and still more preferably 80 mass % or more. Here, the liquid oil is an oil having fluidity after being left to stand at 5 °C for 24 hours. The upper limit of the content of the liquid oil in the fats and oils contained in the fats and oils composition for a choux pastry may be 100 mass %, or may be a value obtained by subtracting the content of the fats and oils powder having a melting point of 50 °C or higher as described above from 100 mass %. The use of the fats and oils composition rich in liquid oil facilitates kneading of the liquid oil into the choux pastry dough.

According to an embodiment of the present invention, the fats and oils composition for choux may include, in addition to 5 to 70 mass % of sodium caseinate and/or casein peptide and 25 to 90 mass % of fats and oils, an auxiliary material generally used for a fats and oils composition such as shortening. Examples of the auxiliary material include emulsifiers such as lecithin, glycerin fatty acid ester, and sucrose fatty acid ester, thickening stabilizers such as gelatin, guar gum, and xanthan gum, salting agents such as salt and potassium chloride, acidulants such as acetic acid, lactic acid, and gluconic acid, saccharides, sugar alcohols, sweeteners such as stevia and aspartame, colorants such as β-carotene, caramel, and a red yeast rice pigment, and antioxidants such as tocopherol, tea extract (such as catechin), and rutin. The amount of the auxiliary material contained in the fats and oils composition is preferably 0 to 10 mass %, more preferably 0 to 5 mass %, and still more preferably 0 to 2 mass %.

According to an embodiment of the present invention, the fats and oils composition for choux of the present invention is obtained by mixing the sodium caseinate and/or casein peptide with the fats and oils. An example of the mixing method include a method of dispersing and mixing sodium caseinate and/or casein peptide in at least fats and oils in a flowing state by heating or the like. The above-mentioned auxiliary material may be added and mixed at any stage. The fats and oils in a flowing state may be fats and oils obtained by mixing a fats and oils powder having a melting point of 50 °C or higher with fats and oils in a molten state (without fats and oils crystals) at lower than 50 °C (for example, 30 to 48 °C). The mixing ratio (mass ratio) between the fats and oils in a molten state (without fats and oils crystals) at a temperature lower than 50 °C and the fats and oils powder having a melting point of 50 °C or higher is preferably 99:1 to 80:20, more preferably 97:3 to 88:12, and still more preferably 95:5 to 90:10. Examples of the fats and oils powder having a melting point of 50 °C or higher include a powder of fully hydrogenated rapeseed oil, a powder of fully hydrogenated palm oil, and a powder of fully hydrogenated soybean oil.

The average particle diameter of the fats and oils powder having a melting point of 50 °C or higher is preferably 1 to 200 μm, more preferably 5 to 150 μm, and still more preferably 10 to 100 μm. By using the fats and oils obtained by mixing a fats and oils powder having a melting point of 50 °C or higher with fats and oils in a molten state (without fats and oils crystals) at lower than 50 °C. for dispersion mixing with powdery sodium caseinate and/or casein peptide, dispersibility of the powdery sodium caseinate and/or casein peptide in the fats and oils is improved (more uniformly dispersed). The fats and oils composition in which powdery sodium caseinate and/or casein peptide are dispersed and mixed may be cooled to a temperature (for example, 25 °C or lower) at which sufficient plasticity is obtained.

The average particle diameter (effective diameter) means a volume average diameter [MV]. The volume average diameter [MV] is determined by measuring a volume-based particle size distribution by dry measurement using a particle size distribution measuring apparatus (for example, manufactured by Shimadzu Corporation, apparatus name: SALD-2300) based on a laser diffraction scattering method (ISO13320, JIS Z 8825-1). The volume average diameter [MV] can be determined from the following formula using the respective values of the particle diameter of a particle, the volume of the particle, and the sum of the volumes of the particles.

Volume average diameter[MV]=sum of (particle diameter×volume of the particle)/sum of volumes of particles

The choux pastry dough of the present invention includes the fats and oils composition for a choux pastry of the present invention.

In the present invention, the “choux pastry” is not particularly limited as long as it is obtained by baking a choux pastry dough including: the fats and oils composition for a choux pastry of the present invention; grain flour, fats and oils, and eggs as main raw materials; and other raw materials as necessary. Examples of the choux pastry include outer pastries (choux pastries) of western confectionery such as cream puff, eclair, swan, paris brest, and ring choux. A choux pastry dough is a dough before baking (also referred to as a dough or a batter) for obtaining a choux pastry by baking. The content of the fats and oils composition for a choux pastry of the present invention contained in the choux pastry dough of the present invention is preferably 0.3 to 36 mass %, more preferably 1 to 27 mass %, and still more preferably 1.5 to 22 mass %. In particular, when the content of sodium caseinate and/or casein peptide contained in the fats and oils composition for a choux pastry of the present invention is 30 mass % or more, the content of the fats and oils composition for a choux pastry of the present invention contained in the choux pastry dough of the present invention is preferably 0.3 to 20 mass %, more preferably 0.8 to 8 mass %, and still more preferably 1.2 to 3 mass %.

Examples of the “grain flour” include hard flour, medium flour, weak flour, whole wheat flour, brown rice flour, rye flour, corn flour, and rice flour. As the grain flour, one kind or two or more kinds thereof may be used. However, strong flour, medium flour, and weak flour are preferably used as the grain flour in order to impart the natural crispy texture inherent in a choux pastry.

The amount of the grain flour contained in the raw materials for the choux pastry dough is preferably 1 to 45 mass %, more preferably 10 to 40 mass %, and still more preferably 15 to 35 mass %.

The “fats and oils” include the fats and oils contained in the fats and oils composition for choux of the present invention. That is, the fats and oils contained in the choux pastry dough may include edible fats and oils other than the fats and oils contained in the fats and oils composition for choux of the present invention. Here, the edible fats and oils are as described above. The edible fats and oils other than the fats and oils contained in the fats and oils composition for choux of the present invention may be contained in the form of a fats and oils composition such as so-called butter, margarine, or shortening. In the fats and oils contained in the choux pastry dough of the present invention, the fats and oils contained in a material in the form of being not a fats and oils composition, such as egg, are excluded. The amount of the fats and oils contained in the raw materials for the choux pastry dough is preferably 1 to 40 mass %, more preferably 5 to 30 mass %, and still more preferably 8 to 25 mass %. The “fats and oils” may include liquid oil. When the choux pastry dough contains liquid oil, it is easy to obtain a soft choux pastry after baking. There is a demand for a soft choux pastry as a choux pastry confection having a texture different from that of a conventional one. The content of the liquid oil in the “fats and oils” is preferably 10 to 70 mass %, more preferably 20 to 55 mass %, and still more preferably 25 to 45 mass %.

As the “eggs”, any eggs can be used. For example, a chicken egg is preferable, and one or two or more selected from whole egg, fresh egg, liquid egg, egg white, egg yolk, frozen egg, frozen egg white, frozen egg yolk, dried egg white, dried egg yolk, other egg products, and processed egg products can be used.

The amount of the eggs contained in the raw materials for the choux pastry dough is preferably 20 to 50 mass %, more preferably 25 to 50 mass %, and still more preferably 30 to 45 mass %.

As a matter of course, an example of the “other raw materials” is “water”, The “water” may be any water as long as it is suitable for eating and drinking, and examples thereof include tap water, spring water, groundwater (well water), distilled water, and ion exchange water. The amount of water (water itself to be blended, excluding water derived from the raw materials) contained in the raw materials for the choux pastry dough is preferably 14 to 40 mass %, more preferably 16 to 35 mass %, and still more preferably 18 to 30 mass %. When the amount of water contained in the raw materials for the choux pastry dough is about the above range, it is easy to obtain a choux pastry having sufficient voids and volume.

In addition, as the “other raw materials”, for example, saccharides such as fructose, glucose, sucrose, maltose, lactose, sorbitol, and maltitol, organic acid salts such as sodium citrate and phosphate, inorganic salts such as salt and calcium chloride, starches such as corn starch, potato starch, tapioca starch, rice starch, and various processed starches, emulsifiers such as polyglycerin fatty acid ester, sucrose fatty acid ester, sorbitan fatty acid ester, monoglyceride, and organic acid monoglyceride, vitamins such as vitamin A, vitamin B, vitamin E, and vitamin C, dairy products such as cow milk, whole fat milk powder, skimmed milk powder, milk powder, and creaming powder, processed products such as cocoa powder, chocolate, chocolate, chips, caramel, cheese, and nuts, as well as seasonings, flavors, coloring agents, rising agents, modifying agents, and preservatives can be appropriately blended.

The present invention also includes a food product containing the choux pastry of the present invention. Examples thereof include cream puff, eclair, swan, paris brest, and ring choux. Examples of the form of these food products include those obtained by wrapping or inserting one kind or two or more kinds of filling materials such as custard cream, cream, jam, marshmallow, and bean jam with or between choux pastries. The food product containing the choux pastry of the present invention also includes a food product obtained by coating or covering the surface of the choux pastry with chocolate, sugar, fats and oils, or the like to give a taste combination.

The method for producing the choux pastry of the present invention is not particularly limited as long as it is a conventional prescription. Details of the method for producing a choux pastry are described in “Confectionary Dictionary” edited by Hisao Watanabe, Asakura Publishing Co., Ltd., 1981, pp. 358-361.

Here, the conventional prescription will be specifically described. A choux pastry is produced by adding fats and oils to water and boiling the mixture, then adding grain flour and kneading the mixture until it becomes a paste, then adding eggs to adjust the hardness to an appropriate level, piping out the mixture on a top plate or the like, and baking the piped-out mixture in an oven. In addition, there is also a method of frying using a fryer instead of an oven. It is desirable that the kneaded choux dough (choux pastry dough) be baked as immediately as possible while its properties do not change, but it is also possible to freeze the kneaded choux dough and then thaw and bake the frozen choux dough. According to an embodiment of the present invention, the fats and oils composition for choux of the present invention may be used as “fats and oils (or a part of fats and oils)” to be added to the water to be boiled.

As described above, the fats and oils composition for a choux pastry of the present invention is easy to produce even when the content of sodium caseinate and/or casein peptide is high. When the fats and oils composition for choux of the present invention is used, it is easy to produce a choux pastry excellent in texture, shape, internal phase, and volume.

### EXAMPLES

Next, the present invention will be described in more detail with reference to Examples and Comparative Examples, but the present invention is not limited thereto at all.

Hereinafter, “%” indicates mass % unless otherwise specified.

### <Milk Protein-Related Powder>

As the milk protein-related powder, the followings were used.
Sodium caseinato (manufactured by Fonterra Japan)
Casein peptide (trade name: Emulup, manufactured by Morinaga Milk Industry Co., Ltd.)
Skimmed milk powder (manufactured by Yotsuba Milk Products Co., Ltd.)

### <Preparation 1 of Fats and Oils Composition for Choux Pastry>

A fats and oils composition for a choux pastry was prepared according to the formulation in Table 1. Specifically, the fats and oils powder was dispersed in palm oil or rapeseed oil which had been melted and maintained at 45 °C. While the fats and oils powder was uniformly dispersed, other raw material powders were added and uniformly mixed to obtain a mixture. The mixture was allowed to stand at room temperature and cooled to obtain an unkneaded fats and oils composition for a choux pastry.

TABLE 1
Formulation (mass %) of fats and oils composition
for choux pastry and SFC (%) of fats and oils

| | Comparative | Example | Example | Example | Example |
|---|---|---|---|---|---|
| | Example 1 | 1 | 2 | 3 | 4 |
| Formulation | | | | | |
| Palm oil | 52 | 52 | 52 | 52 | — |
| Rapeseed oil | — | — | — | — | 52 |
| Fats and oils powder* | 3 | 3 | 3 | 3 | 3 |
| Skimmed milk powder | 45 | — | — | — | — |
| Sodium caseinate | — | 45 | 22.5 | — | 45 |
| Casein peptide | — | — | 22.5 | 45 | — |
| Total | 100.0 | 100.0 | 100.0 | 100.0 | 100.0 |
| SFC | | | | | |
| 10 °C | 53.0 | 53.0 | 53.0 | 53.0 | 5.4 |
| 25 °C | 17.6 | 17.6 | 17.6 | 17.6 | 5.4 |

*Powder of fully hydrogenated rapeseed oil (melting point: 67 °C, average particle diameter: 9.0 μm)

### <Production 1 of Choux Pastry>

According to the formulation of a choux pastry in Table 2, choux pastries of Comparative Example 2 and Examples 5 to 8 using the fats and oils compositions of Comparative Example 1 and Examples 1 to 4, respectively, as the fats and oils composition were produced by a known method. In addition, one using butter as the fats and oils composition was used as Reference Example. Specifically, first, a fats and oils composition for a choux pastry having a formulation shown in Table 2, butter, water, and salt were put in a pot, and heated and boiled. After the mixture was heated and boiled, the heating was temporarily stopped. Sieved weak flour was added thereto, and the mixture was well kneaded. The mixture was further kneaded while further heating at low heat. The pot was removed from the fire, and the kneaded material was transferred to a mixer bowl, and added with loosened whole egg little by little (about 5 ml/sec) while rotating at a low speed. The choux pastry dough thus obtained was piped out on a top plate (25 g±0.5 g), and baked in an oven at an upper flame of 200 °C and a lower flame of 200 °C for 38 minutes to produce a choux pastry. The produced choux pastry was left to cool at room temperature, placed in a plastic bag, and allowed to stand at 5 °C overnight until measurement.

TABLE 2
Formulation 1 of choux pastry

| Formulation | (g) | (mass %) |
|---|---|---|
| Water | 130 | 24.03 |
| Salt | 1 | 0.18 |
| Butter | 90 | 16.64 |
| Fats and oils composition for choux pastry | 10 | 1.85 |
| Weak flour | 100 | 18.48 |
| Whole egg | 210 | 38.82 |
| Total | 541 | 100.0 |

### <Evaluation 1 of Choux Pastry>

The workability of the choux pastry doughs produced above, and the texture, internal phase, shape, and volume of the choux pastries were evaluated according to the following evaluation method. The results are shown in Table 3.

### <Method for Evaluating Choux Pastry>

### (1) Workability of Choux Pastry Doughs

An artisan skilled in the production of a choux pastry made evaluations according to the following evaluation criteria.
Excellent: There is moderate viscosity, and workability such as piping out is very good.
Good: There is viscosity, and workability such as piping out is good.
Fair: Can be piped out, but slightly loose or slightly hard.
Poor: Loose or hard such that piping out is impossible.

### (2) Method for Evaluating Texture

The evaluation was comprehensively performed by five skilled panelists according to the following criteria.
Excellent: Good crispness and moderately soft texture.
Good: Crispy, but slightly hard or soft.
Fair: Good crispness not felt, and hard or soft.
Poor: Poor crispness.

### (3) Method for Evaluating Internal Phase

The evaluation was comprehensively performed by five skilled panelists according to the following criteria.
Excellent: There are moderate voids, and the state of the tissue is very good.
Good: There are moderate voids, and the state of the tissue is good.
Fair: Voids are slightly small or large, and the tissue is clogged or rough.
Poor: Both the voids and the state of the tissue are poor.

### (4) Method for Evaluating Shape

The evaluation was comprehensively performed by five skilled panelists according to the following criteria.
Excellent: Voluminousness and shape are good.
Good: Voluminousness and shape are slightly good.
Fair: Voluminousness and shape are slightly poor.
Poor: Voluminousness and shape are poor.

### (5) Numerical Measurement on Voluminousness

The volume, height, and specific volume of the pastry are obtained by measuring the average values of five choux pastry samples. The volume, height, and specific volume of the choux pastry after baking were measured with a 3D laser volumetric meter (ASTEX 3DLaser Volume Measurement Selnac-Win VM2100).

TABLE 3
Evaluation results 1 of choux pastry

| | Reference | Comparative | | | | |
|---|---|---|---|---|---|---|
| | Example | Example 2 | Example 5 | Example 6 | Example 7 | Example 8 |
| Fats and oils composition | Butter | Comparative | Example 1 | Example 2 | Example 3 | Example 4 |
| | | Example 1 | | | | |
| Evaluation items | | | | | | |
| Workability | Fair | Fair | Excellent | Excellent | Excellent | Good |
| Texture | Good | Good | Excellent | Excellent | Excellent | Excellent |
| Internal phase | Fair | Fair | Excellent | Excellent | Excellent | Excellent |
| Shape | Fair | Fair | Excellent | Excellent | Excellent | Excellent |
| Voluminousness | | | | | | |
| Volume (cm³) | 136 | 128 | 155 | 150 | 167 | 169 |
| Height (mm) | 52.2 | 50.4 | 57.8 | 57.8 | 59.0 | 59.4 |
| Specific volume (cm³/g) | 9.7 | 9.1 | 10.7 | 10.3 | 11.6 | 11.8 |

### <Preparation 2 of Fats and Oils Composition for Choux Pastry>

According to the formulation in Table 4, fats and oils compositions for a choux pastry of Examples 9 and 10 were prepared in the same procedure as in <Preparation 1 of fats and oils composition for choux pastry>.

### [Table 4]

TABLE 4
Formulation (mass %) of fats and oils composition
for choux pastry and SFC (%) of fats and oils

| | Example 9 | Example 10 |
|---|---|---|
| Formulation | | |
| Blending fats and oils*1 | 88 | — |
| Rapeseed oil | — | 88 |
| Fats and oils powder*2 | 3 | 3 |
| Skimmed milk powder | — | — |
| Sodium caseinate | 9 | 9 |
| Casein peptide | — | — |
| Total | 100.0 | 100.0 |
| SFC | | |
| 10 °C | 48.4 | 5.4 |
| 25 °C | 17.8 | 5.4 |

*11:1 (mass ratio) mixed fats and oils of palm oil and palm olein transesterified oil
*2Powder of fully hydrogenated rapeseed oil, (melting point: 67 °C, average particle diameter: 9.0 μm)

### <Production 2 of Choux Pastry>

According to the formulation of a choux pasty in Table 5, choux pastries of Examples 11 and 12 using the fats and oils compositions of Examples 9 and 10, respectively, as the fats and oils composition for a choux pastry were produced in the same procedure as in <Production 1 of choux pastry>.

### [Table 5]

TABLE 5
Formulation 2 of choux pastry

| Formulation | (g) | (mass %) |
|---|---|---|
| Water | 130 | 24.03 |
| Salt | 1 | 0.18 |
| Butter | 50 | 9.24 |
| Fats and oils composition for choux pastry | 50 | 9.24 |
| Weak flour | 100 | 18.48 |
| Whole egg | 210 | 38.82 |
| Total | 541 | 99.99 |

### <Evaluation 2 of Choux Pastry>

The workability of the choux pastry doughs produced above, and the texture, internal phase, shape, and volume of the choux pastries were evaluated in the same evaluation method as in <Evaluation 1 of choux pastry>. The results are shown in Table 6.

TABLE 6
Evaluation results 2 of choux pastry

| | Example 11 | Example 12 |
|---|---|---|
| Fats and oils composition | Example 9 | Example 10 |
| Evaluation items | | |
| Workability | Excellent | Excellent |
| Texture | Excellent | Good |
| Internal phase | Excellent | Excellent |
| Shape | Excellent | Excellent |
| Voluminousness | | |
| Volume (cm³) | 160 | 150 |
| Height (mm) | 58.6 | 57.1 |
| Specific volume (cm³/g) | 10.8 | 9.8 |

* Good crispness, and soft

### <Production 3 of Choux Pastry>

According to the formulation of a choux pastry in Table 7, choux pastries of Examples 13 to 16 using the fats and oils composition of Example 1 as the fats and oils composition for a choux pastry were produced in the same procedure as in <Production 1 of choux pastry>.

### <Evaluation 3 of Choux Pastry>

The workability of the choux pastry doughs produced above, and the texture, internal phase, shape, and volume of the choux pastries were evaluated in the same evaluation method as in <Evaluation 1 of choux pastry>. The results are shown in Table 7.

### [Table 7]

TABLE 7
Formulation (mass %) and evaluation of choux pastry

| | Example | Example | Example | Example |
|---|---|---|---|---|
| | 13 | 14 | 15 | 16 |
| Water | 24.03 | 24.03 | 24.03 | 24.03 |
| Salt | 0.18 | 0.18 | 0.18 | 0.18 |
| Butter | 18.07 | 17.66 | 16.80 | 14.79 |
| Fats and oils composition | 0.41 | 0.82 | 1.68 | 3.70 |
| of Example 1 | | | | |
| Weak flour | 18.48 | 18.48 | 18.48 | 18.48 |
| Whole egg | 38.82 | 38.82 | 38.82 | 38.82 |
| Total | 99.99 | 99.99 | 99.99 | 100.0 |
| Evaluation items | | | | |
| Workability | Good | Good | Excellent | Excellent |
| Texture | Good | Good* | Excellent | Excellent |
| Internal phase | Excellent | Excellent | Excellent | Excellent |
| Shape | Good | Good | Excellent | Excellent |
| Voluminousness | | | | |
| Volume (cm³) | 136 | 134 | 148 | 167 |
| Height (mm) | 51.4 | 52.5 | 55.5 | 59.3 |
| Specific volume (cm³/g) | 9.4 | 9.3 | 10.3 | 11.5 |

1. A fats and oils composition for a choux pastry, comprising 5 to 70 mass % of sodium caseinate and/or casein peptide and 25 to 90 mass % of fats and oils.

2. The fats and oils composition for a choux pastry according to claim 1, wherein the fats and oils contain a fats and oils powder.

3. The fats and oils composition for a choux pastry according to claim 1, which is substantially anhydrous.

4. A choux pastry dough comprising 0.8 to 16 mass % of the fats and oils composition for a choux pastry according to claim 1.

5. A choux pastry in a state in which the choux pastry dough according to claim 4 is baked.

6. A method for producing the fats and oils composition for a choux pastry according to claim 1, comprising
dispersing powdery sodium caseinate and/or casein peptide in at least fats and oils in a flowing state.
